(19) United States
(12) Patent Application Publication
(10) Pub. No.: US 2017/0256806 A1
(43) Pub. Date: Sep. 7, 2017

(54) FUEL CELL SYSTEM AND METHOD OF CONTROLLING FUEL CELL SYSTEM

(71) Applicant: TOYOTA JIDOSHA KABUSHIKI KAISHA, Toyota-shi (JP)

(72) Inventors: Tomohiro OGAWA, Miyoshi-shi (JP); Tsuyoshi MARUO, Toyohashi-shi (JP); Hiroyuki TSUNEKAWA, Seto-shi (JP)

(73) Assignee: TOYOTA JIDOSHA KABUSHIKI KAISHA, Toyota-shi (JP)

(21) Appl. No.: 15/446,108

(22) Filed: Mar. 1, 2017

(30) Foreign Application Priority Data
Mar. 4, 2016 (JP) 2016-042187

(51) Int. Cl. H01M 8/04791; H01M 8/04082; H01M 8/0444; H01M 8/0432; H01M 8/0438

(52) U.S. Cl. CPC H01M 8/04798; H01M 8/0432; H01M 8/0438; H01M 8/0444; H01M 8/04201; H01M 2250/20

(57) ABSTRACT

When a temperature measured by a temperature measurer is below a specified temperature, a controller of a fuel cell system activates a fuel-gas-concentration increasing mechanism by using electric power of a secondary battery, and executes a fuel-gas-concentration increasing process for increasing the fuel gas concentration toward a first target concentration. When the fuel gas concentration reaches equal to or more than a second target concentration lower than the first target concentration, the controller starts power generation by a fuel cell to activate the fuel-gas-concentration increasing mechanism by using electric power from the fuel cell, and executes the fuel-gas-concentration increasing process until the fuel gas concentration reaches the first target concentration or more.

### CROSS REFERENCE TO OTHER APPLICATIONS

The present application claims priority from Japanese patent application (application number 2016-042187) under the title of invention of “FUEL CELL SYSTEM AND METHOD OF CONTROLLING FUEL CELL SYSTEM” filed on Mar. 4, 2016, the entirety of the disclosure of which is hereby incorporated by reference into this application.

### BACKGROUND

The present disclosure relates to a fuel cell system and a control method for a fuel cell system.

At start-up of a fuel cell system under a low temperature environment such as below the freezing point, moisture remaining in a fuel gas flow path within a fuel cell stack may be frozen. The freeze of the moisture prevents distribution of enough fuel gas to the fuel gas flow path, and causing an insufficient fuel gas concentration that leads problems of degradation and instability of the fuel cell's power-generation performance as well as damage to the fuel cell. In order to solve this problem, a low-temperature start-up processing technique has been proposed in which the fuel gas concentration in the fuel gas flow path is increased prior to start-up of the fuel cell system under a low temperature environment.

In the low-temperature start-up process, an injector is actuated to feed a fuel gas to the anode side of the fuel cell so that impurities such as nitrogen and moisture remaining on the anode side are discharged to outside of the fuel cell along with similarly remaining fuel gas such as hydrogen. Therefore, this process involves reducing a discharge hydrogen concentration in discharge gas to a specified concentration level or lower. The reduction of discharge hydrogen concentration is achieved by actuating a blower that supplies oxidizing gas on the cathode side so that anode discharge gas is mixed with cathode discharge gas. Since the fuel cell has not been started up at the time of execution of the low-temperature start-up process, electric power of a secondary battery is used to drive the blower, the injector, and the like.

However, since the electromotive ability of the secondary battery also lowers under a low temperature environment, electric energy supplied from the secondary battery is limited. As a result, in some cases the hydrogen concentration in the fuel gas flow path cannot be increased to a desired hydrogen concentration, which means that the low-temperature start-up process cannot be completed. Also, depending on the charged state of the secondary battery, the low-temperature start-up process has to be stopped at an even lower hydrogen concentration in the fuel gas flow path, as a further problem.

### SUMMARY

Accordingly, there has been desired a technique that allows the hydrogen concentration in the fuel gas flow path to be increased to a desired hydrogen concentration level, i.e. that allows the low-temperature start-up process to be completed, without being affected by the electric-power suppliability of the secondary battery under a low temperature environment.

The present disclosure is accomplished to solve the above-described problems and can be embodied in the following aspects.

A first aspect provides a fuel cell system. The fuel cell system in accordance with the first aspect includes: a fuel cell having a fuel gas flow path inside; a secondary battery; a fuel-gas-concentration increasing mechanism for increasing fuel gas concentration in the fuel gas flow path; a temperature measurer configured to measure a temperature related to the fuel cell; and a controller configured to activate the fuel-gas-concentration increasing mechanism by using electric power of the secondary battery to execute a fuel-gas-concentration increasing process for increasing the fuel gas concentration toward a first target concentration when a temperature measured by the temperature measurer is below a specified temperature, wherein when the fuel gas concentration reaches equal to more than a second target concentration that is lower than the first target concentration, the controller starts power generation by the fuel cell to activate the fuel-gas-concentration increasing mechanism by using electric power from the fuel cell, and executes the fuel-gas-concentration increasing process until the fuel gas concentration reaches the first target concentration or more.

According to the fuel cell system of the first aspect, during execution of the fuel-gas-concentration increasing process, when the fuel gas concentration reaches equal to more than the second target concentration lower than the first target concentration that is a target concentration at a time of completion of the fuel-gas-concentration increasing process, the controller starts power generation by the fuel cell to activate the fuel-gas-concentration increasing mechanism by using electric power from the fuel cell. Therefore, under a low temperature environment, the hydrogen concentration in the fuel gas flow path of the fuel cell can be increased up to a desired hydrogen concentration without being affected by the electric-power suppliability of the secondary battery.

A second aspect provides a method of controlling a fuel cell system. The method of controlling a fuel cell system in accordance with the second aspect comprises: acquiring a temperature related to a fuel cell having a fuel gas flow path inside; when the acquired temperature is below a specified temperature, to increasing fuel gas concentration in the fuel gas flow path toward a first target concentration by activating a fuel-gas-concentration increasing mechanism configured to increase fuel gas concentration in the fuel gas flow path by using electric power of a secondary battery; when the fuel gas concentration reaches equal to more than a second target concentration lower than the first target concentration, increasing the fuel gas concentration until the fuel gas concentration reaches the first target concentration or more by starting power generation by the fuel cell and activating the fuel-gas-concentration increasing mechanism with electric power from the fuel cell; when the fuel gas concentration reaches the first target concentration or more, controlling operation of the fuel cell in response to a power request; and when the acquired temperature is equal to or more than the specified temperature, controlling operation of the fuel cell in response to a power request.

According to the method of controlling a fuel cell system in accordance with the second aspect, the same functional effects as in the fuel cell system of the first aspect can be obtained. Also, the method of controlling a fuel cell system in accordance with the second aspect can be embodied various coping modes in the same manner as with the fuel cell system in accordance with the first aspect.

The present disclosure can be implemented as a control program for a fuel cell system and a computer program product in which embedded a control program for a fuel cell system.

### BRIEF DESCRIPTION OF DRAWINGS

The present disclosure is illustrated by way of example, and not by way of limitation, in the figures of the accompanying drawings and in which like reference numerals refer to similar element and in which:

FIG. 1 is an explanatory view schematically showing a configuration of a fuel cell system according to a first embodiment;

FIG. 2 is an explanatory view showing a vehicle on which the fuel cell system according to the first embodiment is mounted;

FIG. 3 is an explanatory view for explaining a reason of the need for hydrogen-concentration increasing process;

FIG. 4 is a flowchart showing a processing routine of the hydrogen-concentration increasing process according to the first embodiment;

FIG. 5 is a time chart showing operating states of individual components in the hydrogen-concentration increasing process;

FIG. 6 is an explanatory view for explaining a theory of estimating the hydrogen concentration in the fuel gas flow path by using cumulative fuel offgas amount;

FIG. 7 is an explanatory view schematically showing a configuration of a fuel cell system according to a second embodiment;

FIG. 8 is a flowchart showing a processing routine of hydrogen-concentration increasing process according to the second embodiment:

FIG. 9 is a time chart showing operating states of individual components in the hydrogen-concentration increasing process according to the second embodiment;

FIG. 10 is an explanatory view showing a structure around a fuel offgas outlet in a first modification; and

FIG. 11 is an explanatory view showing a structure of an oxidizing gas supply system in a second modification.

### DETAILED DESCRIPTION OF EMBODIMENTS

A fuel cell system and a control method for a fuel cell system according to the present disclosure will be described hereinbelow.

### First Embodiment

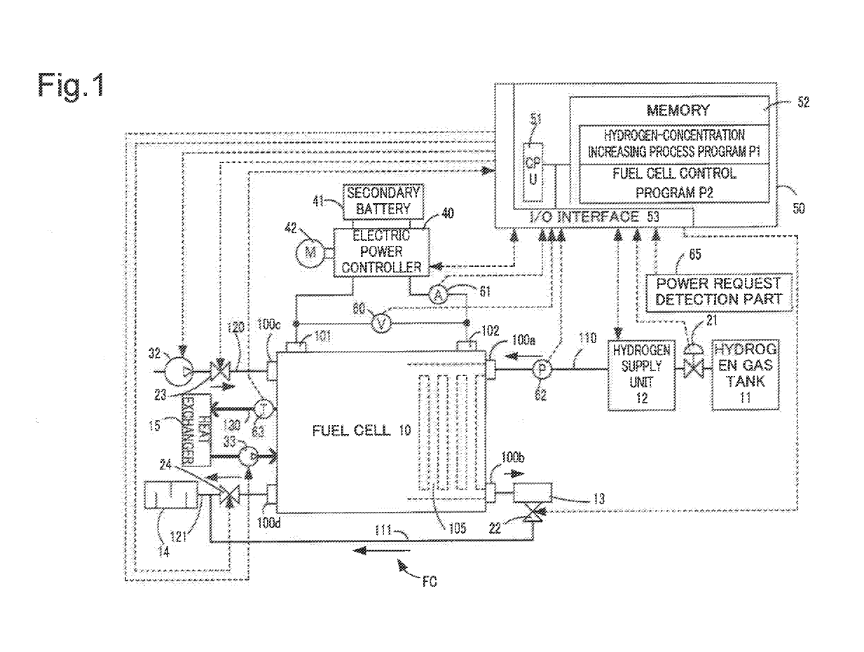

FIG. 1 is an explanatory view schematically showing a configuration of a fuel cell system according to a first embodiment. The fuel cell system FC includes a fuel cell 10, a fuel gas supply system, an oxidizing gas supply system, a cooling system, and a controller 50. In this embodiment, the term ‘reactant gas’ is referred to generically as fuel gases and oxidizing gases that are supplied for electrochemical reactions in the fuel cell 10. The fuel gases include, for example, pure hydrogen and hydrogen-rich gas containing higher hydrogen content, and the oxidizing gases include, for example, air (atmospheric air) and oxygen.

The fuel cell 10 has an anode to which fuel gas is supplied, and a cathode to which oxidizing gas is supplied. In this embodiment, a solid polymer type fuel cell is used, and the fuel cell 10 includes an MEA (Membrane Electrode Assembly) in which an anode catalyst layer carrying an anode catalyst and a cathode catalyst layer carrying a cathode catalyst are provided on respective surfaces of electrolyte membranes. In addition to the anode catalyst layer and the cathode catalyst layer, an anode gas diffusion layer and a cathode gas diffusion layer formed from a material of high gas diffusivity, e.g., porous material or expanded metal may be provided.

An electrolyte layer can be formed of solid polymer electrolyte membrane, e.g., proton-conductive ion exchange membrane formed from fluorine-based resins including perfluorocarbon sulfonic acid. The anode catalyst layer and the cathode catalyst layer include catalysts for promoting electrochemical reactions, e.g., catalysts formed from a noble metal such as platinum (Pt) or platinum alloy or from a noble metal alloy composed of a noble metal and other metals. Each catalyst layer may be formed by being applied onto the surface of each electrolyte layer or may be formed integrally with each gas diffusion layer by making each gas diffusion layer carrying a catalyst metal. An electrically-conductive, gas-permeable material, e.g., carbon porous material or carbon paper may be used as each gas diffusion layer.

The fuel cell 10 includes a fuel gas flow path 105, anode-side fuel gas inlet 100a and fuel offgas outlet 100b, and cathode-side oxidizing gas inlet 100c and oxidizing offgas outlet 100d. The fuel gas inlet 100a and the fuel offgas outlet 100b are communicated (connected) with each other via the fuel gas flow path 105.

The fuel gas supply system includes a hydrogen gas tank 11, a hydrogen supply unit 12, a fuel gas supply pipe 110, and a fuel offgas discharge pipe 111. The hydrogen gas tank 11 is a hydrogen storage unit for storing hydrogen gas at high pressure to supply hydrogen as the fuel gas. In addition to this, a hydrogen storage unit using hydrogen storage alloy or carbon nanotube or a hydrogen storage unit, for storing liquid hydrogen may also be used.

The fuel gas inlet 100a of the fuel cell 10 and the hydrogen gas tank 11 are connected to each other by the fuel gas supply pipe 110. On the fuel gas supply pipe 110, a pressure control valve 21, the hydrogen supply unit 12, and a pressure sensor 62 are located. The pressure control valve 21 regulates the pressure of fuel gas supplied from the hydrogen gas tank 11 to a specified pressure, and moreover sets a valve-closed state in response to a valve-closing request from the controller 50 to stop the fuel gas supply from the hydrogen gas tank 11 to the fuel cell 10. The hydrogen supply unit 12 reduces the pressure of the fuel gas having a specified pressure released (supplied) from the hydrogen gas tank 11 in compliance with a control signal from the controller 50, and also regulates the fuel gas flow rate to a desired flow rate to supply the fuel gas to the fuel cell 10. The hydrogen supply unit 12 as a fuel gas supply unit may include, for example, a single or plural hydrogen injectors. The hydrogen supply unit 12 and a later-described fuel offgas discharge valve 22 configures a fuel-gas-concentration increasing mechanism for increasing the fuel gas concentration in the fuel gas flow path 105. The pressure sensor 62 detects a pressure in the fuel cell 10, i.e., a pressure of the fuel gas flow path 105.

At the fuel offgas outlet 100b of the fuel cell 10, a gas-liquid separator 13 and a fuel offgas discharge valve 22 are located. One end of the fuel offgas discharge pipe 111 is connected to the fuel offgas discharge valve 22, while the other end of the fuel offgas discharge pipe 111 is connected to an oxidizing offgas discharge pipe 121. The gas-liquid separator 13 separates gas components and liquid components contained in the fuel offgas from each other. The fuel offgas discharge valve 22 is controlled by the controller 50 so as to permit discharge of liquid components, mainly generated water, from the gas-liquid separator 13 in the valve-opened state and to stop discharge of the liquid components from the gas-liquid separator 13 in the valve-closed state. The fuel offgas discharge valve 22, which is normally closed, is periodically opened so as to discharge liquid components accumulated in the gas-liquid separator 13 via the fuel offgas discharge pipe 111 and the oxidizing offgas discharge pipe 121 to outside of the fuel cell 10.

The oxidizing gas supply system includes an oxidizing gas supply pipe 120, an oxidizing gas blower 32, an oxidizing offgas discharge pipe 121, and a muffler 14. The oxidizing gas supply pipe 120 is connected to the oxidizing gas inlet 100c of the fuel cell 10. The oxidizing gas blower 32 and the fuel cell 10 are connected to each other via the oxidizing gas supply pipe 120. On the oxidizing gas supply pipe 120, a first cathode sealing valve 23 for sealing the cathode from atmospheric air is provided. The oxidizing offgas discharge pipe 121 is connected to the oxidizing offgas outlet 100d of the fuel cell 10. A second cathode sealing valve 24 and a muffler 14 are provided on the oxidizing offgas discharge pipe 121. The second cathode sealing valve 24 regulates the cathode pressure in cooperation with the oxidizing gas blower 32, and moreover seals the cathode from atmospheric air in cooperation with the first cathode sealing valve. The muffler 14 reduces discharge sounds generated due to discharge of the cathode offgas.

The fuel cell 10 has an anode terminal 101 and a cathode terminal 102 as output terminals. The anode terminal 101 and cathode terminal 102 are connected to a secondary battery 41 and a drive motor 42 as a load via an electric power controller 40. In this embodiment, a lithium ion battery is used as the secondary battery 41, and a three-phase AC motor is used as the drive motor 42. Alternatively, a nickel hydrogen battery or a capacitor may be used as the secondary battery 41, and a DC motor or another AC motor may be used as the drive motor 42. The secondary battery 41 is charged with electric power generated by the fuel cell 10 or regenerative power acquired during deceleration of the vehicle. Electric power stored in the secondary battery 41 is used to drive auxiliary machines at a start of operation of the fuel cell 10 or to drive the vehicle by the drive motor 42 without operating the fuel cell 10. When the fuel cell system FC is mounted on a vehicle, the load includes, for example, by not only the drive motor 42 but also an actuator (not shown, mostly motor) for driving of auxiliary machines that serve to actuate the fuel cell 10.

The electric power controller 40 includes: a first DC-to-DC converter for stepping down an output voltage of the secondary battery 41 to output the stepped-down voltage to low-voltage auxiliary machines; an inverter for converting a DC current derived from the fuel cell 10 or the secondary battery 41 into an AC current in order to drive the drive motor 42 or for converting an AC current acquired by power generation by the drive motor 42 during regeneration into a DC current; and a second DC-to-DC converter for stepping up an output voltage of the secondary battery 41 to a drive voltage for the drive motor 42 and for stepping down an output voltage of the fuel cell 10 and an output voltage of the drive motor 42 during regeneration in order to charge the secondary battery 41.

The electric power controller 40 controls electric charge or discharge of the secondary battery 41, and also controls an SOC (State Of Charge) of the secondary battery 41 so that the SOC of the secondary battery 41 falls within a specified range. The electric power controller 40 controls rotation of the drive motor 42 in compliance with a control signal derived from the controller 50, and also executes control of charge for accumulating in the secondary battery 41 electric power generated by the drive motor 42 that serves as an electric generator during regeneration.

A voltmeter 60 as a voltage measurer for measuring a voltage of the fuel cell is connected to the anode terminal 101 and the cathode terminal 102 to measure an output voltage of overall cells included in the fuel cell 10. An ammeter 61 is located on a power cable connected to the cathode terminal 102 of the fuel cell 10.

The cooling system includes a heat exchanger 15, a coolant pump 33, and a temperature sensor 63 as a temperature measurer. The fuel cell 10 and the heat exchanger 15 are connected to each other via a coolant pipe 130. On the coolant pipe 130, the coolant pump 33 for circulating the coolant in the coolant pipe 130 is located. The temperature sensor 63, which is located on the coolant pipe 130 connected to the exit side of the heat exchanger 15, measures a coolant temperature. In addition, the coolant, which is used as a refrigerant, may be water or antifreeze or otherwise a cooling material that exhibits phase changes between gas and liquid to perform heat transfer, for example, with atmospheric air.

The controller 50 controls actions of the fuel cell system FC in response to a power request inputted from a power request detection part 65. The power request detection part 65 includes, for example, an accelerator pedal for detecting a power request from a driver, and a control part for auxiliary machines of the fuel cell system FC. The controller 50 includes a CPU (Central Processing Unit) 51, a memory 52, and an I/O (input-output) interface 53. The CPU 51, the memory 52, and the I/O interface 53 are connected to one another by a two-way communication bus. The CPU 51 executes programs stored in the memory 52 to control operations of the fuel cell system FC. The CPU 51 may be a multithread CPU, or is used also as a genetic designation of a set of plural CPUs. The memory 52 has stored a hydrogen-concentration increasing process program P1 for executing hydrogen-concentration increasing process, which is a process for increasing the hydrogen concentration in the fuel gas flow path 105 at a start of the fuel cell system, and a fuel cell control program P2 for executing operation control process for the overall fuel cell system FC. These programs P1, P2 are executed by the CPU 51 to function as a hydrogen-concentration increasing process execution unit and a fuel cell control unit, respectively. The memory 52 also includes a working area for temporarily storing computation results by the CPU 51. The I/O interface 53 is an interface to which measurement signal lines and control signal lines are connected to provide connections between the controller 50 and various sensors and actuators provided outside the controller 50. In this embodiment, an unshown accelerator opening sensor as a power request sensor, the hydrogen supply unit 12, the pressure control valve 21, the fuel offgas discharge valve 22, the first, second cathode sealing valves 23, 24, the oxidizing gas blower 32, the coolant pump 33, and the electric power controller 40 are connected to the I/O interface 53 via the control signal lines. Moreover the voltmeter 60, the ammeter 61, the pressure sensor 62, and the temperature sensor 63 are connected to the I/O interface 53 via the measurement signal lines.

The operation of the fuel cell system FC will be explained briefly. The high-pressure hydrogen gas stored in the hydrogen gas tank 11 is reduced in pressure by the pressure control valve 21, and thereafter regulated to specified pressure and fuel gas flow rate by the hydrogen supply unit 12, thus being supplied to the anode of the fuel cell 10 via the fuel gas supply pipe 110 and the fuel gas inlet 100a. Fuel offgas (anode offgas) containing fuel gas that is supplied into the fuel cell 10 and has not been involved in electromotive reactions. The fuel offgas is introduced at a specified timing via the fuel offgas outlet 100b and the fuel offgas discharge pipe 111 to the oxidizing offgas discharge pipe 121, diluted to lower than a specified hydrogen concentration by cathode offgas and released into the atmospheric air through the muffler 14.

Air (atmospheric air) gathered by the oxidizing gas blower 32 is supplied to the cathode of the fuel cell 10 via the oxidizing gas supply pipe 120 and the oxidizing gas inlet 100c. During operation of the fuel cell 10, the controller 50 sets the first, second cathode sealing valves 23, 24 to the valve-opened state.

Hydrogen supplied to the anode is separated into hydrogen ions (protons) and electrons by the anode catalyst layer, then the hydrogen ions moving to the cathode via the MEA and the electrons moving to the cathode catalyst layer via an external circuit. The hydrogen ions having moved to the cathode react with oxygen supplied to the cathode and electrons passed via the external circuit in the cathode catalyst layer, by which water is generated. By a series of these reactions, an electric current for driving the load can be obtained.

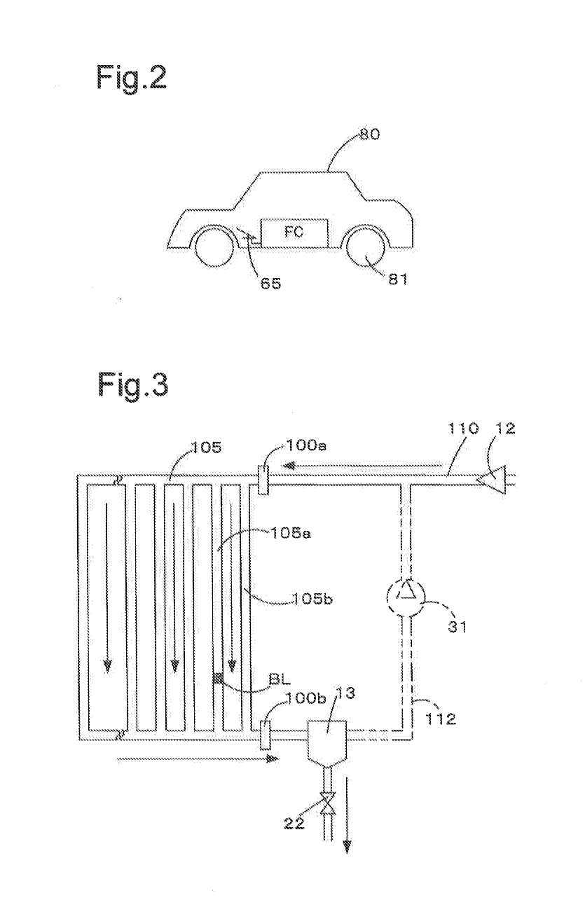

FIG. 2 is an explanatory view showing a vehicle on which the fuel cell system according to the first embodiment is mounted. In this embodiment, the fuel cell system FC is mounted on a vehicle (passenger car) 80. Based on a power request inputted from the accelerator pedal serving as the power request detection part 65, the controller 50 performs the above-described process to supply electric power from the fuel cell 10 to the drive motor 42 so that wheels 81 are driven to drive the vehicle 80.

The hydrogen-concentration increasing process as a fuel-gas-concentration increasing process according to the first embodiment will be explained below. Herein, since hydrogen gas is used as the fuel gas, the fuel gas is in some cases referred to as hydrogen gas (hydrogen). First, the reason of executing the hydrogen-concentration increasing process is explained. FIG. 3 is an explanatory view for explaining a reason of the need for hydrogen-concentration increasing process. In FIG. 3, component elements related to the first embodiment are depicted by solid line, and component elements related to the second embodiment alone are depicted by two-dot chain line. Upon stop of operation of the fuel cell 10, a purge process for discharging moisture in the fuel gas flow path 105 to outside of the fuel cell 10 to fill the anode side with the fuel gas is executed. However, it is impracticable to discharge the entire moisture in the fuel gas flow path 105, with the result that residual water content remains in the fuel gas flow path 105. When the fuel cell 10 is put under a low temperature environment, e.g., under an atmosphere below the freezing point (lower than 0 degrees), residual water in the fuel gas flow path 105 is frozen to become an iced body BL. In particular, after overnight parking of the vehicle and after long-time parking in the daytime, the iced body BL is more likely to be generated. The iced body BL blocks a fuel gas flow path 105a or acts as a flow resistance to the fuel gas in the fuel gas flow path 105a, making it less likely that hydrogen being the fuel gas is delivered to the fuel gas flow path 105a, as compared with a fuel gas flow path 105b in which no iced body BL is present. As a result, there arises an insufficiency of fuel gas (insufficiency of fuel gas concentration) in the fuel gas flow path 105a in which the iced body BL is present, so that degradation and instability of power-generation performance of the fuel cell 10 as well as damage to the fuel cell may result. Accordingly, at a low-temperature start-up of the fuel cell 10, a hydrogen-concentration increasing process is executed in which the fuel offgas discharge valve 22 is opened to supply the fuel gas from the hydrogen supply unit 12 and replace residual gas or the like in the fuel gas flow path 105 with the fuel gas.

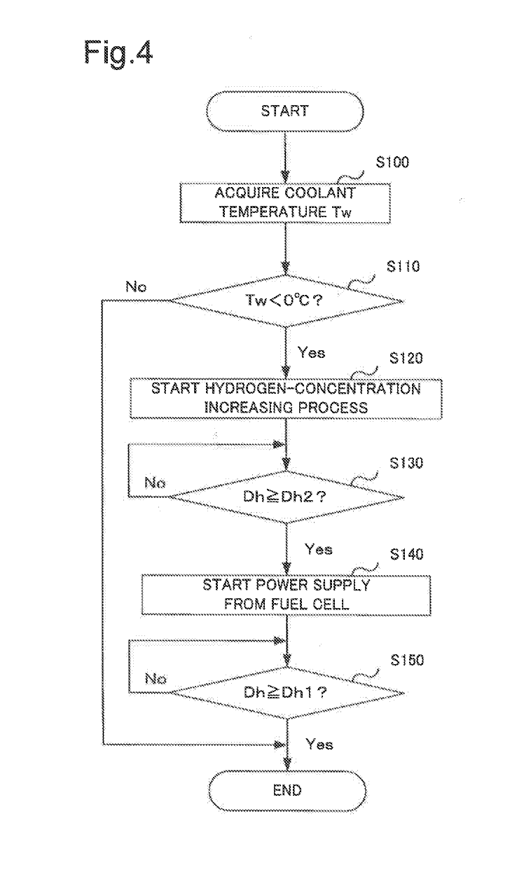

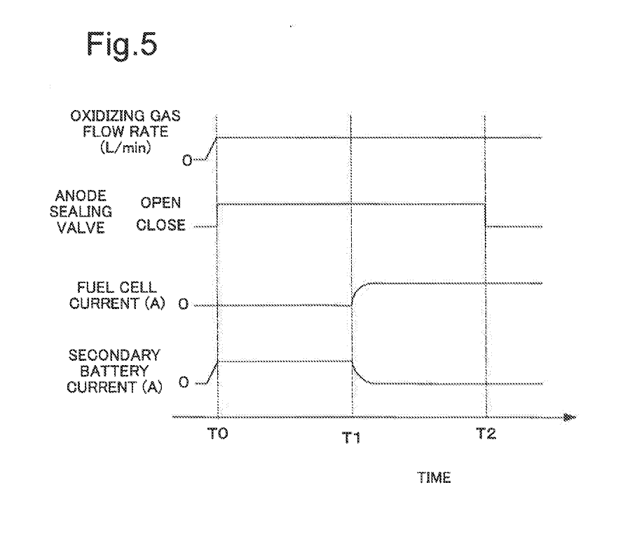

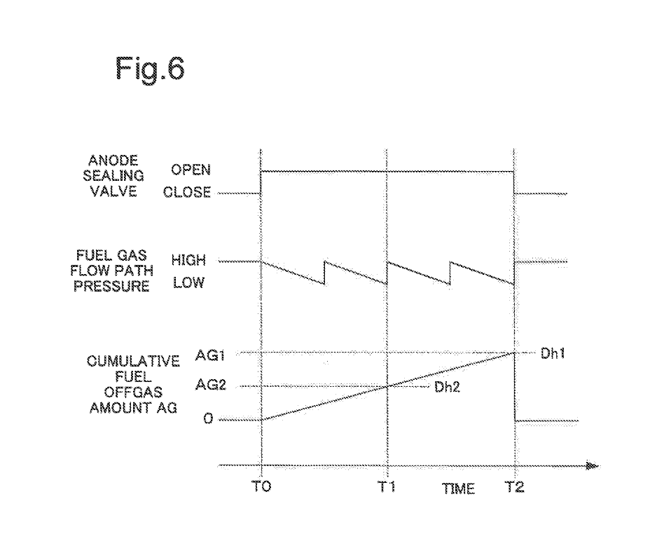

FIG. 4 is a flowchart showing a processing routine of the hydrogen-concentration increasing process according to the first embodiment. FIG. 5 is a time chart showing operating states of individual components in the hydrogen-concentration increasing process. FIG. 6 is an explanatory view for explaining a theory of estimating the hydrogen concentration in the fuel gas flow path by using cumulative fuel offgas amount. The hydrogen-concentration increasing process according to the first embodiment is fulfilled by the controller 50 (CPU 51) executing the hydrogen-concentration increasing process program P1.

Upon receiving an ON-input, of a start-up switch for starting up the fuel cell system, the CPU 51 executes the hydrogen-concentration increasing process program P1, acquiring a coolant temperature Tw (° C.) measured by the temperature sensor 63 (step S100). The coolant temperature Tw, which is a temperature related to the fuel cell 10 (fuel cell system FC), is used as an index indicative of an internal temperature of the fuel cell 10 (temperature of the fuel gas flow path 105). In addition, in this embodiment, the temperature sensor 63 delivers to the controller 50 a measured value (voltage value, current value) corresponding to a temperature value. The CPU 51 decides whether the coolant, temperature Tw is less than 0° C. (Tw<0° C.), i.e., whether the temperature of the fuel cell 10 is below the freezing point (step S110).

When it is decided that the coolant temperature Tw is not less than 0° C. (Tw≧0° C.) (No at step S110), the CPU 51 terminates the processing routine and executes the fuel cell control program P2 for operating the fuel cell 10 in response to a power request.

When it is decided that the coolant temperature Tw is less than 0° C. (Yes at step S110), the CPU 51 starts the hydrogen-concentration increasing process (step S120). The CPU 51 transmits a valve-opening signal to the fuel offgas discharge valve 22 and transmits a hydrogen supply signal to the hydrogen supply unit 12 (T0). The CPU 51 transmits an oxidizing gas supply signal to the oxidizing gas blower 32, and transmits a valve-opening signal to the first cathode sealing valve 23 and the second cathode sealing valve 24 (T0). Hereinbelow, the hydrogen supply unit 12, the fuel offgas discharge valve 22, the first cathode sealing valve 23, the second cathode sealing valve 24, and the oxidizing gas blower 32, which are operated during the hydrogen-concentration increasing process, will be referred to generically as objective auxiliary machines. In the fuel offgas discharge valve 22 and the first second cathode sealing valves 23, 24, which have received the valve-opening signal, the valves are opened by unshown actuator with electric power of the secondary battery 41. In the hydrogen supply unit 12 and the oxidizing gas blower 32, which have received the supply signal, unshown injector and pump are actuated with electric power of the secondary battery 41. That is, at a start of the hydrogen-concentration increasing process, the secondary battery 41 is connected to the individual objective auxiliary machines, where actuators of the objective auxiliary machines are driven with electric power of the secondary battery 41 while the fuel cell 10 non-connected to the individual auxiliary machines does not perform power generation. In FIGS. 5 and 6, the horizontal axis represents elapsed time (sec), T0 corresponds to a start time of the hydrogen-concentration increasing process, T1 correspond to a time when the fuel gas concentration (hydrogen concentration) has arrived at a second target concentration Dh2, and T2 corresponds to a time when the hydrogen-concentration increasing process has been completed. In addition, in the hydrogen-concentration increasing process, since operations of the individual auxiliary machines are controlled depending not on the elapsed time but on the fuel gas concentration, T1 and T2 are not necessarily the same timing.

When the hydrogen-concentration increasing process is started, residual gas remaining in the fuel gas flow path 105 is pushed out toward the fuel offgas outlet 100b by hydrogen gas supplied by the hydrogen supply unit 12. Residual gas and hydrogen gas that have reached the fuel offgas outlet 100b, passing through the gas-liquid separator 13 and the fuel offgas discharge valve 22, are led via the fuel offgas discharge pipe 111 to the oxidizing offgas discharge pipe 121. In the oxidizing gas supply system, the oxidizing gas blower 32 is operated so that oxidizing gas is supplied from the oxidizing gas inlet 100c to an unshown oxidizing gas flow path and discharged from the oxidizing offgas outlet 100d to the oxidizing offgas discharge pipe 121. Therefore, the residual gas and the hydrogen gas led to the oxidizing offgas discharge pipe 121 are diluted by the oxidizing offgas until the hydrogen concentration becomes below a specified concentration, and thereafter those gases are released into the atmospheric air from the muffler 14.

The CPU 51 decides whether a fuel gas concentration (hydrogen concentration) Dh in the fuel gas flow path 105 reaches a second target concentration Dh2 (step S130), and the above process is continued until the condition Dh≧Dh2 is met (No at step S130). A first target concentration Dh1, which is targeted for processing end in the hydrogen-concentration increasing process, corresponds to a hydrogen concentration required in order that an electric power for driving the drive motor 42 in response to a power request from the power request detection part 65 is generated by the fuel cell 10. Therefore, fulfillment of the first target concentration Dh1 may require time and, particularly under a low temperature environment, electromotive performance of the secondary battery 41 may also degrade, so that not enough electric energy could be obtained and the first, target concentration Dh1 might be unachievable. Accordingly, in the first embodiment, a second target concentration Dh2, which is a hydrogen concentration required for power generation needed to drive the objective auxiliary machines and which is lower than the first, target concentration Dh1, is introduced. Under this condition, at a time point when it has been satisfied that Dh≧Dh2, the power generation by the fuel cell 10 is started so that the objective auxiliary machines are driven independent of the electric power of the secondary battery 41, thus the hydrogen-concentration increasing process being completed. In addition, the second target concentration Dh2 is such a hydrogen concentration that even executing power generation causes no damage to the fuel cell 10, i.e., no deterioration of the catalyst, or causes the catalyst to be deteriorated only to a small extent, such a hydrogen concentration being a characteristic value which is empirically determined and preparatorily defined for each of individual types of the fuel cell system FC.

In this embodiment, a cumulative fuel offgas amount AG, which is a cumulative discharge gas amount (L) of fuel offgas discharged since the start of the hydrogen-concentration increasing process, is used as an index for evaluating (estimating) a hydrogen concentration Dh in the fuel gas flow path 105, instead of directly detecting a hydrogen concentration in the fuel gas flow path 105, expediently, a hydrogen concentration Dh in fuel offgas by using a fuel gas concentration sensor such as a hydrogen concentration sensor. That is, the hydrogen concentration Dh in the fuel gas flow path 105 is evaluated by using a first fuel offgas amount AG1 corresponding to the first target concentration Dh1 as well as a second fuel offgas amount AG2 corresponding to the second target concentration Dh2, which are predetermined based on a relationship between fuel gas concentration (hydrogen concentration) and cumulative fuel offgas amount. It can be said that the CPU 51 acquires and evaluates a fuel gas concentration simulatedly by using the cumulative fuel offgas amount AG. In addition, the process of determining the cumulative fuel offgas amount AG, and the decisions with use of the cumulative fuel offgas amount AG as to whether the fuel gas concentration is equal to or more than the first target concentration Dh1 as well as whether it is equal to or more than the second target concentration Dh2 may be executed by a CPU different, from the CPU 51, where decision results are offered to the CPU 51 in order that the fuel-gas-concentration increasing process by the CPU 51 is executed. This theory will be explained with reference to FIGS. 3 and 6.

The hydrogen-concentration increasing process is, in other words, a process of replacing residual gas in the fuel gas flow path 105 with hydrogen gas. The capacity of the fuel gas supply pipe 110 ranging from the hydrogen supply unit 12 to the fuel gas inlet 100a, the total capacity of the fuel gas flow path 105, and the capacity of the fuel offgas discharge pipe 111 ranging from the fuel offgas outlet 100b to the fuel offgas discharge valve 22 as well as the capacity of the gas-liquid separator 13 are already known in terms of design. Accordingly, the supply hydrogen gas amount to be supplied for fulfillment of the first target concentration Dh1, which is the hydrogen concentration required for stable operation of the fuel cell 10, i.e., the first fuel offgas amount AG1 (gas amount for replacement) to be discharged from the fuel offgas outlet 100b is also calculatable. In addition, since the fuel offgas discharge valve 22 is opened in the hydrogen-concentration increasing process, the pressure of the fuel gas flow path 105 lowers along with the discharge of the fuel offgas. Thus, as shown in FIG. 6, hydrogen gas is supplied to the fuel cell 10 intermittently so that the pressure of the fuel gas flow path 105 is maintained at a specified pressure (a pressure between high and low). As a result of this, the fuel offgas is discharged also intermittently. Therefore, in this embodiment, the term ‘cumulative fuel offgas amount AG’ is used to explicitly represent a total amount of intermittently discharged cumulative fuel offgas amounts. The fuel offgas amount can be determined by substituting a pressure of the fuel gas flow path 105 detected by the pressure sensor 62 placed on the fuel gas supply pipe 110 into van der Waals' equation of state.

Therefore, the decision at step S130 as to whether Dh≧Dh2 is executed by using the second fuel offgas amount AG2, which is to be discharged for fulfillment of the second target concentration Dh2. In more detail, the CPU 51 acquires a pressure of the fuel gas flow path 105 detected via the pressure sensor 62, calculates a cumulative fuel offgas amount AG by using the acquired pressure, and decides whether cumulative fuel offgas amount AG≧second fuel offgas amount AG2. With use of a relationship between the first target concentration Dh1 and the first fuel offgas amount, AG1 as well as the predetermined second target concentration Dh2, the second fuel offgas amount AG2 is determined, for example, by proportional calculation, or alternatively determined empirically for each of individual types of the fuel cell system FC. Although the second fuel offgas amount AG2 is set to a 50% value of the first fuel offgas amount AG1 in the example of FIG. 6, yet this is only an example and the second fuel offgas amount AG2 may be a 30% to 70% value of the first fuel offgas amount AG1, for instance.

Upon deciding that Dh≧Dh2 (Yes at step S130), the CPU 51 starts power supply from the fuel cell 10 to objective auxiliary machines (step S140). This event corresponds to the time point T1 in FIGS. 5 and 6. The CPU 51 makes the fuel cell 10 and the objective auxiliary machines connected to each other and transmits a valve-closing signal to the fuel offgas discharge valve 22 while keeping the other objective auxiliary machines continuing operations. As a result, the fuel cell 10 starts power generation, and the generated power is used for driving of actuators of the individual objective auxiliary machines. As shown in FIG. 5, the CPU 51 gradually increases the power generation (current value) of the fuel cell 10 while gradually decreasing the current value of the secondary battery 41. Then, when the electric power required for driving of the individual objective auxiliary machines reaches be suppliable by the fuel cell 10, the power supply for the individual objective auxiliary machines from the secondary battery 41 is stopped.

The CPU 51 decides whether the hydrogen concentration Dh in the fuel gas flow path 105 reaches the first target concentration Dh1 or more (step S150), and continues until Dh≧Dh1 (No at step S150). Upon deciding that Dh≧Dh1 (Yes at step S150), the CPU 51 terminates this processing routine, completing the hydrogen-concentration increasing process. In addition, the cumulative fuel offgas amount AG is used also for the decision as to whether the hydrogen concentration Dh has reached the first target concentration Dh1. By using the pressure of the fuel gas flow path 105 acquired from the pressure sensor 62, the CPU 51 decides whether the cumulative fuel offgas amount AG reaches the first fuel offgas amount AG1 or more, thereby deciding whether Dh≧Dh1.

According to the fuel cell system FC of the first embodiment as described above, the controller 50 starts power generation by the fuel cell 10 at the second target concentration Dh2, which is lower than the first target concentration Dh1 serving as a completion target of the hydrogen-concentration increasing process, the controller 50 thus drives objective auxiliary machines with electric power of the fuel cell instead of the electric power of the secondary battery 41. As a consequence, the hydrogen-concentration increasing process can be completed without depending on the power capacity of the secondary battery 41.

In the first embodiment, the cumulative fuel offgas amount AG discharged from the fuel cell 10 is used to decide whether the hydrogen concentration in the fuel gas flow path 105 reaches the first or second target concentration Dh1, Dh2 or more. Therefore, whether the hydrogen concentration in the fuel gas flow path 105 reaches the first or second target concentration Dh1, Dh2 or more can be decided based on parameters that involve less errors due to the measurement environment and which are easier to measure. In addition, estimating the hydrogen concentration with use of the cumulative fuel offgas amount AG is a sufficiently significant technique for the hydrogen-concentration increasing process as described above. Also, since detecting the presence or absence of hydrogen of a specified concentration is not involved, whether the hydrogen concentration in the fuel gas flow path 105 reaches the first or second target concentration Dh1, Dh2 or more can be decided without newly using any hydrogen concentration sensor for measurement of the hydrogen concentration.

### Second Embodiment

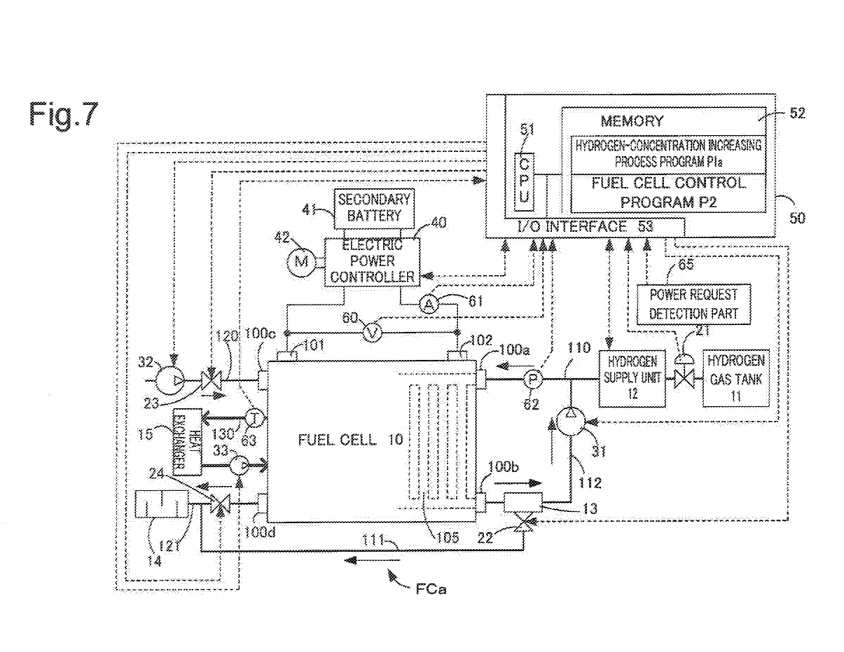

Hereinbelow, a fuel cell system FCa according to a second embodiment will be described. FIG. 7 is an explanatory view schematically showing a configuration of a fuel cell system according to the second embodiment. The fuel cell system FCa according to the second embodiment differs from the fuel cell system FC of the first embodiment in that the fuel cell system FCa includes a fuel offgas circulation system for reloading fuel offgas to the fuel cell 10, and that the fuel cell system FCa includes a hydrogen-concentration increasing process program P1a including the fuel offgas circulation system instead of the hydrogen-concentration increasing process program P1. In addition, the rest of the component members are similar to those of the fuel cell system FC according to the first embodiment, and so those component members are designated by the same reference signs as in the first embodiment with their description omitted.

The fuel offgas circulation system includes a fuel offgas circulation pipe 112 for connecting the fuel offgas outlet 100b of the fuel cell 10 and a portion of the fuel gas supply pipe 110 downstream of the hydrogen supply unit 12 to each other, and a fuel offgas circulation pump 31 placed on the fuel offgas circulation pipe 112. The fuel offgas circulation pump 31 is connected to the I/O interface 53 of the controller 50 via a control signal line, and controlled by the controller 50 so as to reload fuel offgas to the anode and moreover regulate the fuel gas flow rate to be supplied to the anode, by which biases of the fuel gas distribution (fuel gas concentration) in the fuel gas flow path 105 are reduced or prevented. In addition, the fuel offgas circulation pipe 112 may be connected directly to the fuel offgas outlet 100b of the fuel cell without the gas-liquid separator 13 and the fuel offgas discharge valve 22.

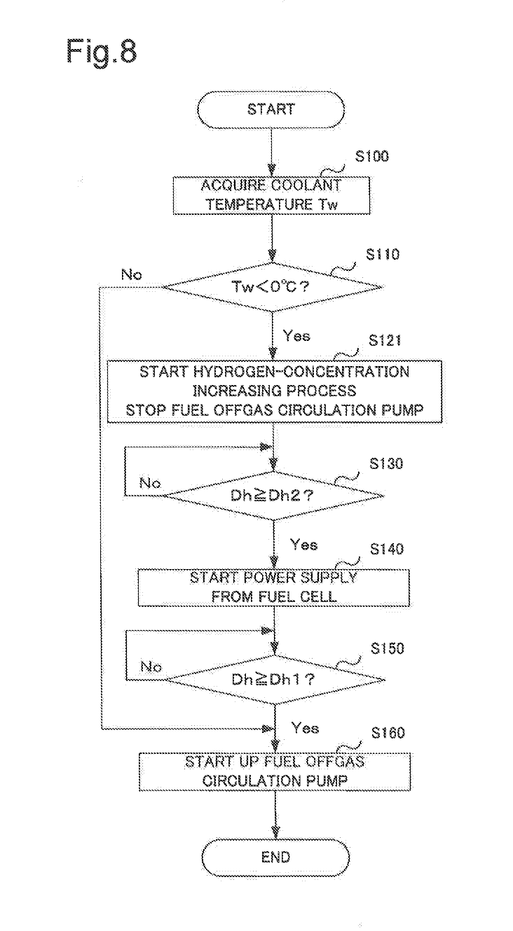

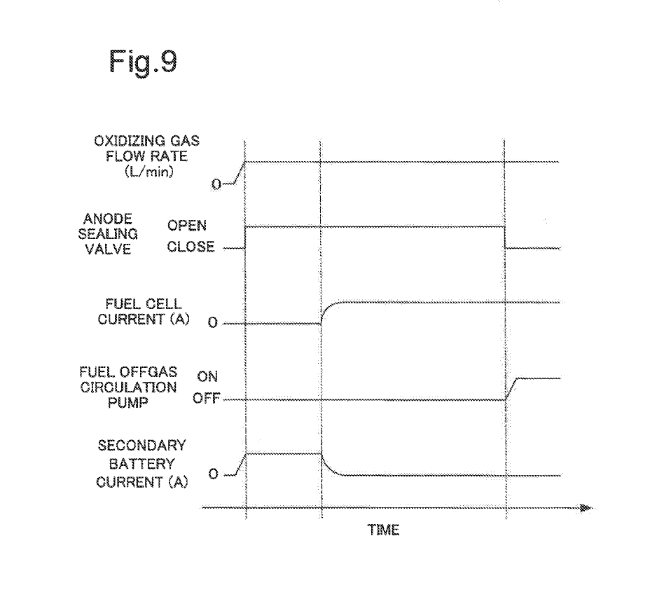

A hydrogen-concentration increasing process in the second embodiment will be described. The hydrogen-concentration increasing process according to the second embodiment is realized by the CPU 51 executing a hydrogen-concentration increasing process program P1a. FIG. 8 is a flowchart showing a processing routine of the hydrogen-concentration increasing process according to the second embodiment. FIG. 9 is a time chart showing operating states of individual components in the hydrogen-concentration increasing process according to the second embodiment. The hydrogen-concentration increasing process of the second embodiment is similar to the hydrogen-concentration increasing process of the first embodiment except that a processing step for the fuel offgas circulation pump 31 is added. As to the rest of the processing steps, the same processing steps as in the hydrogen-concentration increasing process of the first embodiment are designated by the same step numbers as in the first embodiment with their description omitted.

After processing execution of steps S100 and S110, the CPU 51 starts the hydrogen-concentration increasing process (step S121). After stopping the fuel offgas circulation pump 31, the CPU 51 executes the hydrogen-concentration increasing process described in the first embodiment. The fuel offgas circulation pump 31, as already described, is actuated to suppress or prevent dispersion of the fuel gas concentration in the fuel gas flow path 105. Therefore, at a start-up of the fuel cell system FCa, components other than hydrogen remaining in the fuel gas flow path 105 at the last stop of the fuel cell system FCa, e.g., nitrogen and oxygen are dispersively supplied along with hydrogen as the fuel gas to the fuel gas flow path 105. When the iced body BL present on the fuel gas flow path 105a as shown in FIG. 3, nitrogen and oxygen are supplied to the fuel gas flow path 105a, to which hydrogen alone should be supplied naturally, so that the hydrogen concentration could not be increased. As a result, effectiveness of the hydrogen-concentration increasing process serving for compensation of insufficient hydrogen concentration would be lower. Accordingly, in the hydrogen-concentration increasing process, the fuel offgas circulation pump 31 is stopped so that only hydrogen supplied from the hydrogen supply unit 12 is supplied to the fuel gas flow path 105.

After processing execution of steps S130 to S150, the CPU 51, upon completing the hydrogen-concentration increasing process (Yes at step S150), starts up the fuel offgas circulation pump 31 (step S160), ending this processing routine.

According to the fuel cell system FCa of the second embodiment as described above, when the fuel offgas circulation pump 31 is provided, the controller 50 keeps the fuel offgas circulation pump 31 stopped during execution of the hydrogen-concentration increasing process. Accordingly, residual nitrogen, oxygen and the like due to the circulation of fuel offgas, which would obstruct the hydrogen-concentration increasing process, can be prevented from being distributed to the fuel gas flow path 105. As a result, even in the fuel cell system FCa including the fuel offgas circulation pump 31, as in the fuel cell system FC of the first embodiment, the hydrogen-concentration increasing process can be completed without depending on the power capacity of the secondary battery 41.

Modifications will be described hereinbelow.

(1) First Modification:

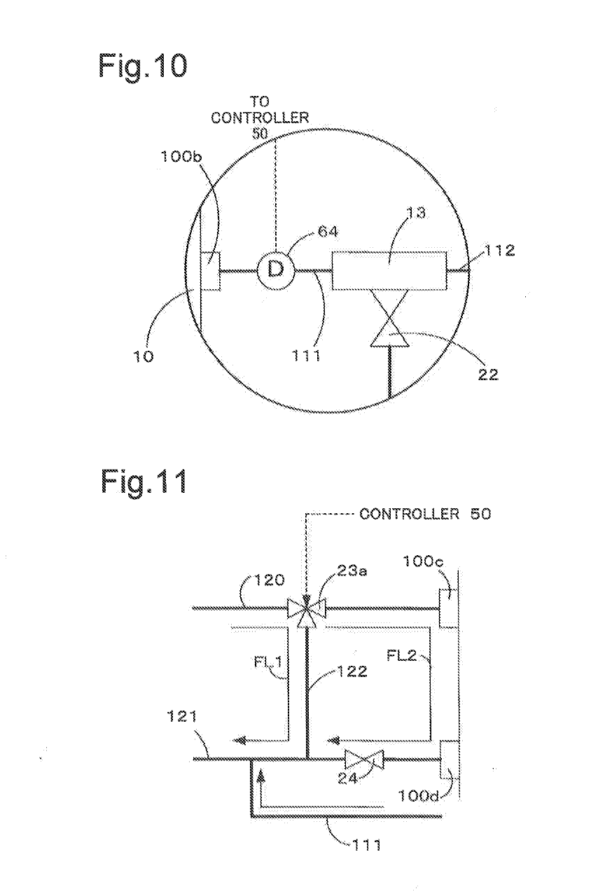

FIG. 10 is an explanatory view showing a structure around a fuel offgas outlet in a first modification. In the foregoing embodiments, whether the hydrogen concentration in the fuel gas flow path 105 reaches the first or second target concentration Dh1, Dh2 or more is decided by using the cumulative fuel offgas amount without measuring the hydrogen concentration in the fuel gas flow path 105 (fuel offgas). In contrast to this, in the first modification, a hydrogen concentration sensor 64 as a fuel-gas concentration acquisition part is provided on the fuel offgas discharge pipe 111 between the fuel offgas outlet 100b and the gas-liquid separator 13. The hydrogen concentration sensor 64 is connected to the I/O interface 53 of the controller 50 via a measurement signal line. Since whether the hydrogen concentration in the fuel gas flow path 105 has reached the two target concentrations, which are the first and second target concentrations Dh1, Dh2, needs to be decided, the hydrogen concentration sensor 64 is not a hydrogen concentration sensor that detects hydrogen concentrations of a specified concentration level or higher, but a hydrogen concentration sensor capable of outputting a measurement signal corresponding to a hydrogen concentration. Use of the hydrogen concentration sensor 64 makes it possible to evaluate the hydrogen concentration in the fuel gas flow path 105 with higher accuracy, so that the start timing of power supply by the fuel cell 10 during the hydrogen-concentration increasing process can be decided more accurately while the possibility of causing damage or the like to the fuel cell 10 is reduced or prevented.

(2) Second Modification:

FIG. 11 is an explanatory view showing a structure of an oxidizing gas supply system in a second modification. The foregoing embodiments include no structure for supplying oxidizing gas derived from the oxidizing gas blower 32 to the oxidizing offgas discharge pipe 121 outside the fuel cell 10. The second modification includes a structure for supplying oxidizing gas derived from the oxidizing gas blower 32 to the oxidizing offgas discharge pipe 121 by bypassing the fuel cell 10. Instead of the first cathode sealing valve 23, a flow dividing valve 23a is placed on the oxidizing gas supply pipe 120. The flow dividing valve 23a and a portion of the oxidizing offgas discharge pipe 121 downstream of the second cathode sealing valve 24 are connected to each other via a bypass pipe 122. The flow dividing valve 23a is connected to the I/O interface 53 of the controller 50 via a control signal line. In order to bypass oxidizing gas derived from the oxidizing gas blower 32, the CPU 51 closes the second cathode sealing valve 24 to realize a bypass flow FL1 in which the oxidizing gas derived from the oxidizing gas blower 32 flows through the bypass pipe 122 alone. Meanwhile, in order to lead the oxidizing gas derived from the oxidizing gas blower 32 to inside of the fuel cell 10, the CPU 51 opens the second cathode sealing valve 24 to realize the bypass flow FL1 in which the oxidizing gas derived from the oxidizing gas blower 32 flows through the bypass pipe 122 as well as a normal flow FL2 in which the oxidizing gas flows inside the fuel cell 10.

When the flow dividing valve 23a and the bypass pipe 122 are provided, in executing the hydrogen-concentration increasing process, the CPU 51 switches over the second cathode sealing valve 24 so as to form the bypass flow FL1 until the hydrogen concentration Dh of the fuel gas flow path 105 reaches the second target concentration Dh2 or more. In this state, the supply of oxidizing gas is being executed to dilute the fuel offgas, and the power generation of the fuel cell 10 has not been started. Accordingly, the supply of oxidizing gas into the fuel cell 10 is unnecessary, and in consideration of pressure loss due to flow path resistance or the like, it is preferable that oxidizing gas is supplied to the oxidizing offgas discharge pipe 121 without passing through inside of the fuel cell 10.

Meanwhile, when the hydrogen concentration Dh of the fuel gas flow path 105 reaches the second target concentration Dh2 or more, the power generation of the fuel cell 10 is started and therefore the CPU 51 gradually opens the second cathode sealing valve 24 to realize the normal flow FL2 in addition to the bypass flow FL1. In addition, at an end of operation of the fuel cell system FC, the anode of the fuel cell 10 is filled with hydrogen for prevention of catalyst deterioration while hydrogen has transferred also to the cathode side via the MEA. Therefore, when starting the supply of oxidizing gas to the fuel cell 10 (at a start of power generation of the fuel cell 10), the CPU 51 closes the fuel offgas discharge valve 22 so as to prevent fuel offgas from being supplied to the oxidizing offgas discharge pipe 121 so that the hydrogen concentration discharged from the oxidizing offgas discharge pipe 121 is set to a specified concentration or lower. At a timing when all the residual oxidizing gas within the cathode can be discharged, the CPU 51 opens the fuel offgas discharge valve 22, continuing the hydrogen-concentration increasing process until the hydrogen concentration Dh of the fuel gas flow path 105 reaches the first target concentration Dh1 or more.

(3) Third Modification:

In the foregoing individual embodiments, the controller 50 may control SOC of the secondary battery 41 in such manner that enough electric power to execute the hydrogen-concentration increasing process has been stored in the secondary battery 41 at an end of operation of the fuel cell system FC. For example, the control may be performed so that electric charging from the fuel cell 10 to the secondary battery 41 is performed depending on the SOC at an end of operation of the fuel cell system FC. Alternatively, forecasting a next-time start of the fuel cell 10 in a low-temperature state based on an outside air temperature during a vehicle run or after a vehicle stop and before an end of operation of the fuel cell system FC, when such a start in a low-temperature state is forecasted, charging control for the secondary battery 41 may be executed so as to satisfy the SOC.

(4) Fourth Modification:

In the foregoing individual embodiments, execution of the hydrogen-concentration increasing process is started when the coolant temperature is less than 0° C., i.e., below the freezing point. However, the hydrogen-concentration increasing process may be executed at less than 4° C. instead of below the freezing point. Generally, it is well known that temperatures lower than 4° C. could cause road surfaces to be frozen due to influences of wind or the like, and similarly, in an environment with the vehicle under influences of wind, moisture in the fuel gas flow path 105 of the fuel cell 10 could be frozen. Thus, in consideration of the environment under which the fuel cell system FC is used, execution of the hydrogen-concentration increasing process may be started by locking up to a reference temperature which is given by a temperature at which moisture in the fuel gas flow path 105 of the fuel cell 10 can be frozen.

(5) Fifth Modification:

In the foregoing individual embodiments, temperatures related to the fuel cell 10 are measured based on the coolant temperature. The temperatures related to the fuel cell 10 may also be measured based on measured temperatures acquired from an outside air temperature sensor or a temperature sensor placed inside the fuel cell 10 as temperature measurers.

(6) Sixth Modification:

In the foregoing individual embodiments, the cumulative fuel offgas amount AG is determined by using a pressure measured by the pressure sensor 62. However, for example, when a flow rate sensor will be provided on the fuel offgas discharge pipe 111 between the fuel offgas outlet 100b and the gas-liquid separator 13, the controller 50 may determine the cumulative fuel offgas amount AG by using a flow rate measured by the flow rate sensor.

(7) Seventh Modification:

In the foregoing individual embodiments, the fuel-gas-concentration increasing mechanism is implemented by the hydrogen supply unit 12 and the fuel offgas discharge valve 22. However, when the hydrogen supply unit 12 is not provided, the fuel-gas-concentration increasing mechanism may be implemented by the pressure control valve 21 and the fuel offgas discharge valve 22. Also, in the case where the hydrogen gas tank 11 and a portion of the fuel offgas circulation pipe 112 upstream of the fuel offgas circulation pump 31 are connected to each other by piping and moreover a valve is placed upstream of the connection position, the fuel-gas-concentration increasing mechanism may be implemented by the above-mentioned valve, the fuel offgas circulation pump 31 and the fuel offgas discharge valve 22.

(8) Eighth Modification:

The foregoing individual embodiments have been described on a case in which the fuel cell system FC is mounted on a vehicle. Both automobiles and motorcycles are applicable as the vehicle, and otherwise applying those embodiments to mobile bodies such as railroad rolling stock and vessels allows similar technical effects to be obtained. The fuel cell system FC also may be a fixed type fuel cell system with a second battery.

Although the present disclosure has been described hereinabove by way of embodiments and modifications, the above-described modes for carrying out the disclosure are dedicated to an easier understanding of the disclosure and should not be construed as limiting the disclosure. The disclosure may be changed and improved without departing its gist and the appended claims for the disclosure, and equivalents of those changes and improvements are included in the disclosure. For example, technical features in the embodiments and modifications corresponding to technical features in the individual modes described in the section of SUMMARY may be interchanged or combined in various ways as required in order to solve part or entirety of the above-described problems or to achieve part or entirety of the above-described advantageous effects. Furthermore, those technical features may be deleted as required unless herein described as essentials.

What is claimed is:

1. A fuel cell system comprising:
a fuel cell having a fuel gas flow path inside;
a secondary battery;
a fuel-gas-concentration increasing mechanism for increasing fuel gas concentration in the fuel gas flow path;
a temperature measurer configured to measure a temperature related to the fuel cell; and
a controller configured to activate the fuel-gas-concentration increasing mechanism by using electric power of the secondary battery to execute a fuel-gas-concentration increasing process for increasing the fuel gas concentration toward a first target concentration when a temperature measured by the temperature measurer is below a specified temperature, wherein
when the fuel gas concentration reaches equal to or more than a second target concentration that is lower than the first target concentration, the controller starts power generation by the fuel cell to activate the fuel-gas-concentration increasing mechanism by using electric power from the fuel cell, and executes the fuel-gas-concentration increasing process until the fuel gas concentration reaches the first target concentration or more.

2. The fuel cell system in accordance with claim 1, wherein
the fuel cell includes a fuel gas inlet and a fuel offgas outlet that are communicated with the fuel gas flow path,
the fuel-gas-concentration increasing mechanism includes
a fuel gas supply unit connected to the fuel gas inlet, and
a fuel offgas discharge valve connected to the fuel offgas outlet, and wherein
the controller executing the fuel-gas-concentration increasing process by controlling the fuel gas supply unit so as to fuel gas is supplied to the fuel gas flow path via the fuel gas inlet, and controlling the fuel offgas discharge valve so as to fuel offgas is discharged from the fuel gas flow path via the fuel offgas outlet.

3. The fuel cell system in accordance with claim 2, further comprising:
a fuel gas circulation pipe for connecting the fuel offgas outlet and the fuel gas inlet to each other and circulating the fuel offgas that has been discharged; and
a circulation pump located on the fuel gas circulation pipe, wherein
the controller stops circulation of the fuel offgas by the circulation pump before execution of the fuel-gas-concentration increasing process, and starts the circulation of the fuel offgas by the circulation pump after completion of the fuel-gas-concentration increasing process.

4. The fuel cell system in accordance with claim 1, further comprising:
a pressure sensor configured to measure a pressure of the fuel gas flow path, wherein
the controller has a first fuel offgas amount corresponding to the first target concentration and a second fuel offgas amount corresponding to the second target concentration as previously prepared and calculates a cumulative discharge gas amount of fuel offgas discharged from the fuel cell by using a pressure value measured by the pressure sensor, wherein the controller decides whether the fuel gas concentration is equal to or more than the first target concentration and equal to or more than the second target concentration by deciding whether the calculated cumulative discharge gas amount of the fuel offgas is equal to or more than the first fuel offgas amount and the second fuel offgas amount.

5. The fuel cell system in accordance with claim 1, further comprising:
a flow meter configured to measure a flow rate of fuel offgas discharged from the fuel cell, wherein
the controller has a first fuel offgas amount corresponding to the first target concentration and a second fuel offgas amount corresponding to the second target concentration as previously prepared, and calculates a cumulative discharge gas amount of fuel offgas discharged from the fuel cell by using a flow rate value measured by the flow meter, wherein the controller decides whether the fuel gas concentration is equal to or more than the first target concentration and equal to or more than the second target concentration by deciding whether the calculated cumulative discharge gas amount of the fuel offgas is equal to or more than the first fuel offgas amount and the second fuel offgas amount.

6. The fuel cell system in accordance with claim 1, further comprising:
a fuel gas concentration sensor configured to measure the fuel gas concentration, wherein
the controller decides whether the fuel gas concentration is equal to or more than the first target concentration and equal to or more than the second target concentration by using a fuel gas concentration measured by the fuel gas concentration sensor.

7. The fuel cell system in accordance with claim 1, wherein
the controller executes a fuel-cell operation control process responsive to a power request when a temperature measured by the temperature measurer is equal to or more than the specified temperature or after the fuel gas concentration reaches above the first target concentration and the subsequent fuel-gas-concentration increasing process has been completed.

8. A method of controlling a fuel cell system comprising:
acquiring a temperature related to a fuel cell having a fuel gas flow path inside;
when the acquired temperature is below a specified temperature, increasing fuel gas concentration in the fuel gas flow path toward a first target concentration by activating a fuel-gas-concentration increasing mechanism configured to increase fuel gas concentration in the fuel gas flow path by using electric power of a secondary battery;
when the fuel gas concentration reaches equal to or more than a second target concentration lower than the first target concentration, increasing the fuel gas concentration until the fuel gas concentration comes to the first target concentration or more by starting power generation by the fuel cell and activating the fuel-gas-concentration increasing mechanism with electric power from the fuel cell;
when the fuel gas concentration reaches the first target concentration or more, controlling operation of the fuel cell in response to a power request; and
when the acquired temperature is equal to or more than the specified temperature, controlling operation of the fuel cell in response to a power request.

9. The method of controlling fuel cell system in accordance with claim 8, wherein
the fuel-gas-concentration increasing mechanism includes a fuel gas supply unit connected to a fuel gas inlet of the fuel cell, and a fuel offgas discharge valve connected to a fuel offgas outlet, of the fuel cell, and wherein
the fuel-gas-concentration increasing process is executed by controlling the fuel gas supply unit so as to fuel gas is supplied to the fuel gas flow path via the fuel gas inlet, and controlling the fuel offgas discharge valve so as to fuel offgas is discharged from the fuel gas flow path via the fuel offgas outlet.

10. The method of controlling fuel cell system in accordance with claim 9, wherein the fuel cell system comprising a fuel gas circulation pipe for connecting the fuel offgas outlet and the fuel gas inlet to each other and circulating the fuel offgas that has been discharged; and a circulation pump located on the fuel gas circulation pipe, and
the method further comprising stopping circulation of the fuel offgas by the circulation pump before execution of the fuel-gas-concentration increasing process, and starting the circulation of the fuel offgas by the circulation pump after completion of the fuel-gas-concentration increasing process.

11. The method of controlling fuel cell system in accordance with claim 8, further comprising:
measuring a pressure of the fuel gas flow path, and
the deciding whether the fuel gas concentration is equal to or more than the first target concentration and equal to or more than the second target concentration including:
calculating a cumulative discharge gas amount of fuel offgas discharged from the fuel cell with using a measured pressure value; and
deciding whether the calculated cumulative discharge gas amount of the fuel offgas is equal to or more than a first fuel offgas amount corresponding to the first target concentration as previously prepared and a second fuel offgas amount corresponding to the second target concentration as previously prepared.

12. The method of controlling fuel cell system in accordance with claim 8, further comprising:
measuring a flow rate of fuel offgas discharged from the fuel cell, and
the deciding whether the fuel gas concentration is equal to or more than the first target concentration and equal to or more than the second target concentration including:
calculating a cumulative discharge gas amount of fuel offgas discharged from the fuel cell with using a measured flow rate value measured; and
deciding whether the calculated cumulative discharge gas amount of the fuel offgas is equal to or more than first, fuel offgas amount corresponding to the first target concentration as previously prepared and a second fuel offgas amount corresponding to the second target concentration as previously prepared.

13. The method of controlling fuel cell system in accordance with claim 8, wherein
the deciding whether the fuel gas concentration is equal to or more than the first target concentration and equal to or more than the second target concentration is executed using a fuel gas concentration measured by a fuel gas concentration sensor.

14. The method of controlling fuel cell system in accordance with claim 8, further comprising:
executing a fuel-cell operation control process responsive to a power request when a temperature measured by the temperature measurer is equal to or more than the specified temperature or after the fuel gas concentration reaches above the first target concentration and the subsequent fuel-gas-concentration increasing process has been completed.
